(19) United States
(12) Patent Application Publication
(10) Pub. No.: US 2020/0081127 A1
(43) Pub. Date: Mar. 12, 2020

(54) SET-UP OF TOF SENSORS AND PLATFORM FOR PERCEIVING A CABIN OF A PEOPLE MOVER AND PERCEPTION SYSTEM FOR PERCEIVING A BLOCKAGE OF A CABIN DOOR, A NUMBER OF PASSENGERS INSIDE THE PEOPLE MOVER AND POSITIONS, POSES AND ACTIVITIES OF THE PASSENGERS

(71) Applicant: ZF Friedrichshafen AG, Friedrichshafen (DE)

(72) Inventor: Jörg ANGERMAYER, Friedrichshafen (DE)

(73) Assignee: ZF Friedrichshafen AG, Friedrichshafen (DE)

(21) Appl. No.: 16/567,980

(22) Filed: Sep. 11, 2019

(30) Foreign Application Priority Data
Sep. 12, 2018 (DE) 102018215513.5

(51) Int. Cl. G01S 17/89; G01S 17/02; G01S 17/08; G01S 17/87; H04W 4/42

(52) U.S. Cl. CPC G01S 17/89; G01S 17/026; H04W 4/42; G01S 17/87; G01S 17/08

(57) ABSTRACT

A set-up of TOF sensors for perceiving a passenger cabin in a people mover, comprised of a first TOF sensor, which is placed such that a first field of view of the first TOF sensor perceives a region surrounding a passenger door, in order to detect a blockage of the passenger door, and to count the number of passengers in the passenger cabin, and a second TOF sensor, which is placed such that a second field of view of the second TOF sensor perceives the passengers located in the passenger cabin, and counts the number of passengers in the passenger cabin. The present disclosure also relates to a platform and a perception system.

### RELATED APPLICATIONS

This application claims priority from German Patent Application DE 10 2018 215 513.5, filed Sep. 12, 2018, the entirety of which is hereby incorporated by reference herein.

### TECHNICAL FIELD

The present disclosure relates to a set-up of time-of-flight (TOF) sensors for perceiving a passenger cabin of a people mover. The present disclosure also relates to an evaluation platform for perceiving a passenger cabin of a people mover. The present disclosure also relates to a perception system for detecting a blockage of a passenger door of a people mover, the number of passengers in the people mover, and the positions, poses and activities of the passengers.

### BACKGROUND

Vehicles for transporting people and goods are known from the prior art. In particular, small busses for transporting people short distances, e.g., in cities, airports or trade fairs, also referred to as “people movers,” are vehicles for transporting people.

In the development of automation it is important to monitor the interior of a vehicle for transporting people. Busses in public transport are currently equipped with cameras for example, for monitoring the entryways of the bus.

### SUMMARY

An object of the present disclosure is to improve the monitoring of passenger cabins in small busses with regard to sensor technology and monitoring possibilities using the smallest possible number of sensors.

This object is achieved by a set-up of TOF sensors that has the features disclosed herein. The object is also achieved by a platform for perceiving a passenger cabin of a people mover that has the features disclosed herein. The object is also achieved by a perception system for detecting a blockage of a passenger door in a people mover, the number of people in the people mover and the positions, poses and activities of the passengers, that has the features disclosed herein.

A passenger cabin of a people mover is perceived with the set-up of TOF sensors according to the present disclosure. The set-up is comprised of a first TOF sensor and a second TOF sensor. The first TOF sensor is placed such that a first field of view of the first TOF sensor perceives the region surrounding a passenger door in order to detect a blockage of the passenger door and to count the passengers in the passenger cabin. The second TOF sensor is placed such that a second field of view of the second TOF sensor perceives the passengers in the passenger cabin in order to detect positions, activities and/or poses of the passengers and to count the passengers in the passenger cabin.

A people mover in the framework of the present disclosure is a small bus that can be universally developed and implemented, which can be equipped in particular for public transport. The people mover may be used to transport people short distances, e.g., in cities, on factory premises, on the grounds of research facilities, e.g., universities or other facilities, or in airports or trade fairs. The dimensions of the people mover may be, for example, 4.65×1.95×2.50 meters (length, width, height). The people mover may contain 10 seats and standing room for 5 people. The dimensions of the passenger cabin, i.e., the space into and from which the passengers enter and leave the people mover may be, for example, 3.00×1.85×2.20 meters (length, width, height). The weight of the empty people move may be 2 tons, for example. The people mover preferably comprises an electric drive system, preferably an electric axle driver with an output of 150 kW, and contains a battery capacity for use up to 10 hours. The people mover can be automated, preferably up to the automation level SAE Level 5, i.e., fully automated or autonomously operable.

The automated people mover comprises a technological apparatus, in particular an environment detection system, formed by a supercomputing control unit with artificial intelligence, and intelligent actuators that can control the people mover with a vehicle control system in order to implement driving tasks, including longitudinal and transverse guidance, after activation of a corresponding automatic function, in particular a highly or fully automated driving function according to the standard SAEJ3016. The people mover is equipped in particular for SAE levels 3, 4 and 5. In particular, the present disclosure is used at SAE levels 3 and 4 in a transition period for highly/fully automated driving, in order to be subsequently used at SAE level 5.

At SAE levels 3 and 4 there is a driver, the so-called safety driver, who reacts to demands to intervene, i.e., the safety driver can assume control of the vehicle. People movers for SAE levels 3 and 4 comprise a driver cabin for the safety driver. At SAE level 5, there is no need for a driver cabin. The set-up according to the present disclosure can still be used without a driver cabin.

The people mover also comprises a passenger door for letting the people that are to be transported in and out. The passenger door is preferably located between the front and rear axles, at the side of the vehicle. The passenger door through which the people enter and exit the people mover is designed to open and close automatically in response to the intentions of the passengers.

A TOF sensor, i.e., time-of-flight sensor, is a process runtime sensor. In a TOF sensor, each pixel of the sensor collects incident light and simultaneously measures the runtime required by the light to travel from a source to an object and back to the pixel. Each of the pixels in the TOF sensors converts light into an electrical current. The pixel functions with numerous switches and memory elements dedicated to each switch. In the simplest case, each pixel has two switches and two memory elements. The switches are actuated when a beam impulse is emitted, and opened for the time period of the beam impulse, i.e., the length of the impulse. The control signals for each switch are temporally offset in each case by the length of an impulse.

When a reflected beam impulse strikes the pixel after a delay, only a portion of the beam impulse reaches the first memory element, and the other portion is collected in the second memory element. Depending on the distance, the ratio of light collected in the first memory element to that collected in the second memory element changes. The distance to the perceived object is then established by reading out the pixel and determining the relationships of the signals in the first and second memory element. The functioning of the time-of-flight sensor is disclosed, e.g., in WO 2014/195020 A1.

The field of view of a sensor, abbreviated FOV, is the space in which objects can be perceived. The field of view comprises a horizontal plane, the horizontal field of view, and a vertical plane, the vertical field of view.

It is thus possible with the set-up according to the present disclosure to detect a blockage of the passenger door, the number of passengers, and the positions, activities, and poses of the passengers, using only two sensors. In comparison with other image sensors the TOF sensors have the advantage that they also provide data regarding a depth of field when perceiving a scenario, thus improving the perception. Individual planes in the field of view can also be depicted with a TOF sensor using the depth of field data.

The first TOF sensor is advantageously placed such that at least one passenger who has entered the people mover and is located in the region of the passenger door is perceived in the first field of view. Furthermore, or alternatively, the first TOF sensor is located such that at least one finger, foot, and/or shoe of a passenger in the region of the passenger door when the passenger is located outside and/or inside the people mover is perceived in the first field of view. This is particularly advantageous when the people mover is waiting for passengers to enter and/or exit at a stopping point. By way of example, the people mover waits for a passenger who wants to enter the people mover. The passenger stands in front of the entry to the people mover. The passenger door is opened. For the following cases, the people mover is to open the passenger door and indicate to the passenger that he/should stop blockage the passenger door when:
The passenger enters the people mover and remains in the opening/closing region of the passenger door.
The passenger waits in front of the entry region of the passenger door and does not enter the passenger cabin. The passenger is, however, holding one of his fingers in the region of the passenger door.
The passenger waits in front of the entry region of the passenger door and does not enter the passenger cabin. In this case, the passenger has placed his foot or a shoe in the region of the passenger door.
Numerous passengers, e.g., three, pass through the passenger door together, and remain standing in the opening/closing region of the passenger door.
A passenger is in the people mover in front of the passenger door and does not exit the people mover. The passenger is nevertheless holding one of his fingers in the region of the passenger door.
   The status of any one of these situations is updated in each case within a time window of 1 second.

An example set-up shall be described using a coordinate system as the reference system. The point of origin of the coordinate system is located in the middle of a rear axle of the people mover. The x-axis runs along the longitudinal axis of the people mover toward a front axle of the people mover, i.e., the positive values increase toward the front axle, and the negative values run in the opposite direction. The y-axis is perpendicular to the x-axis along the transverse axis of the people mover, away from the passenger door. The z-axis is perpendicular to both the x-axis and the y-axis, extending away from the floor of the people mover. With respect to this coordinate system, the first TOF sensor, i.e., a reference point of the first TOF sensor, is located at x=1.000 to x=1.100, preferably x=1.044, y=−0.600 to y=−0.200, preferably y=−0.460, and z=1.700 to z=2.000, preferably z=1.900. The second TOF sensor, i.e., a reference point of the second TOF sensor, is located at x=−0.800 to x=−0.200, preferably x=−0.575, y=−0.800 to y=−0.400, preferably y=−0.630, and z=1.800 to z=2.150, preferably z=2.077. As a result of this positioning, the region of the passenger door and the rest of the passenger cabin are surprisingly entirely perceived. The maximum range of 2 meters for the first TOF sensor and the second TOF sensor is sufficient for this.

The first TOF sensor may be placed such that a first roll angle of the first TOF sensor lies in a range of 10⁰ to 18°, preferably at 14°, a first pitch angle of the first TOF sensor lies in a range of 50° to 60°, preferably at 56°, and a first yaw angle of the first TOF sensor lies in a range of 6° to 14°, preferably at 11°. The second TOF sensor may be placed such that a second roll angle of the second TOF sensor lies in a range of 10° to 18°, preferably at 14°, a second pitch angle of the second TOF sensor lies in a range of 50° to 60°, preferably at 56°, and a second yaw angle of the second TOF sensor lies in a range of −50° to −40°, preferably at −43°. As a result of this angular set-up, the region of the passenger door and the rest of the passenger cabin are surprisingly particularly entirely perceived, in particular in combination with the placements according to the present disclosure. A horizontal and vertical field of view of 85° in each case is sufficient for this.

The platform according to the present disclosure perceives a passenger cabin of a people mover. This means that the platform is designed to interpret an environment based on raw sensor data. The platform comprises at least one first interface. The first interface receives data from a first TOF sensor and a second TOF sensor. The first TOF sensor and the second TOF sensor are placed in accordance with a set-up according to the present disclosure. The platform is configured to detect a blockage of a passenger door of the people mover by a passenger based on the data from the first TOF sensor, and to generate a first signal for keeping the passenger door open and/or to stop the blockage by the passenger. The platform is also configured to determine which positions the passengers assume, and also how many passengers there are, in particular whether the passengers are sitting, standing, walking, or lying, which poses, i.e., the physical positions the passengers assume, and which activities the people are engaged in, i.e., listening to music, drinking, reading a book, etc. and to generate a second signal containing information regarding the positions, poses, and/or activities of the passengers. The physical positions, poses and activities of the passengers are advantageously determined by means of artificial intelligence, e.g., using an artificial neural network that has learned to identify poses. The platform is also configured to determine the number of passengers in the passenger cabin based on the data from the first TOF sensor or the data from the second TOF sensor, or a fusion of the data from the first TOF sensor and the second TOF sensor, and to generate a third signal containing the information regarding the number of passengers. The platform also comprises at least one second interface. The second interface sends the first signal to a control mechanism for the passenger door or provides it to the passenger blocking the passenger door. The second interface also sends the second signal and/or the third signal to a control device for the people mover and/or to a display on the people mover.

A platform is a device that processes input information and outputs a result from this processing. In particular, a platform may be an electronic circuit, e.g., a central processing unit or a graphics processor. The platform may be implemented in the form of a system-on-a-chip of an electronic control unit, abbreviated ECU, i.e., all, or at least a majority of the functions are integrated on a chip. The chip may comprise a multi-core processor with numerous central processors, for example, referred to as a “central processing unit”, abbreviated CPU. The chip also comprises numerous graphics processors, referred to as “graphic processing units,” abbreviated GPU. Graphics processing units are particularly advantageously suited for the parallel processing of sequences. The platform can be scaled with a construction of this type, i.e., the platform can be adapted to different SAE levels.

An interface is a mechanical and/or electrical component between at least two functional units at which an exchange of logical values takes place, e.g., data or physical values, e.g., electric signals, either unidirectionally or bidirectionally. The exchange can be analog or digital. The exchange can take place in a wireless or hard-wired manner.

Artificial intelligence is a generic term for the automation of intelligent behavior. By way of example, an intelligent algorithm learns to react to new information in a goal-oriented manner. An artificial neural network is an intelligent algorithm. An intelligent algorithm is configured to learn to react in a goal-oriented manner to new information. The artificial neural network learns, for example, to classify positions, poses and/or activities of the passengers.

The second interface is an interface to a servomotor for the passenger door. By sending the first signal, e.g., an electrical pulse of a specific amplitude and length, to the servomotor, the servomotor continues to hold the passenger door open. Alternatively or additionally, the second interface conducts the first signal to an acoustic, visual, and/or tactile output device, which renders the first signal audible, visible and/or tangible for the passenger. By way of example, there is a display that tells the passenger to leave the region of the passenger door.

The second signal is sent by means of the second interface to a control device for the people mover. The platform is integrated in the control device in the framework of the present disclosure. The control device controls the longitudinal and/or transverse guidance of the people mover based on the second signal by means of electromechanical, preferably intelligent, actuators. As a result, the performance of the people mover can be adapted to the number of passengers, their positions, poses and activities, in order to give the passengers the most comfortable and safe possible riding experience.

The third signal is sent by means of the second interface to a display on the people mover that is visible on the outside of the people mover, in order to inform waiting passengers how many passengers are in the people mover, and thus to indicate the number of possible free spaces in the people mover, or to indicate that the people mover is fully occupied. The number of people and/or the information regarding the positions, poses and activities of the passengers can also be sent to an external control point. In this case, the second interface is preferably a wireless interface. As a result, a remote operator of the people mover receives information regarding the passengers in the passenger cabin.

The perception system according to the present disclosure is used to perceive, i.e., for the perception of, a blockage of a passenger door of a people mover, the number of passengers in the people mover, and the positions, poses, and activities of the passengers. The perception system is composed of a first TOF sensor and a second TOF sensor, placed in accordance with a set-up according to the present disclosure and a platform according to the present disclosure. This results in the aforementioned advantages of the set-up according to the present disclosure, and the platform according to the present disclosure.

### BRIEF DESCRIPTION OF THE DRAWINGS

The present disclosure shall be described by way of example based on the following figures and the associated descriptions.

FIG. 1 shows an illustration of an exemplary embodiment of a people mover according to the present disclosure;

FIG. 2 shows a side view of an exemplary embodiment of a people mover according to the present disclosure;

FIG. 3a shows a top view of an exemplary embodiment of a set-up according to the present disclosure of an exemplary embodiment of a first TOF sensor;

FIG. 3b shows a side view of the exemplary embodiment shown in FIG. 3a;

FIG. 3c shows a perspective view of the exemplary embodiment shown in FIG. 3a;

FIG. 3d shows a schematic illustration of an exemplary embodiment of an angular positioning of the first TOF sensor;

FIG. 3e shows a schematic illustration of the field of view of the exemplary embodiment shown in FIG. 3a;

FIG. 3f shows an actual illustration of the field of view of the exemplary embodiment shown in FIG. 3a;

FIG. 4a shows a top view of an exemplary embodiment of a set-up according to the present disclosure of an exemplary embodiment of a second TOF sensor;

FIG. 4b shows a side view of the exemplary embodiment shown in FIG. 4a;

FIG. 4c shows a perspective view of the exemplary embodiment shown in FIG. 4a;

FIG. 4d shows a schematic illustration of an exemplary embodiment of an angular positioning of the second TOF sensor;

FIG. 4e shows a schematic illustration of a field of view of the exemplary embodiment shown in FIG. 4a;

FIG. 4f shows an actual illustration of the field of view of the exemplary embodiment shown in FIG. 4a; and

FIG. 5 shows an illustration of an exemplary embodiment of a perception system according to the present disclosure.

### DETAILED DESCRIPTION

Identical reference symbols in the figures indicate identical or functionally similar components. For purposes of clarity, only the reference symbols relevant to the understanding of the respective figures are indicated in the individual figures. The components not provided with reference symbols nevertheless retain their original significance and functions therein.

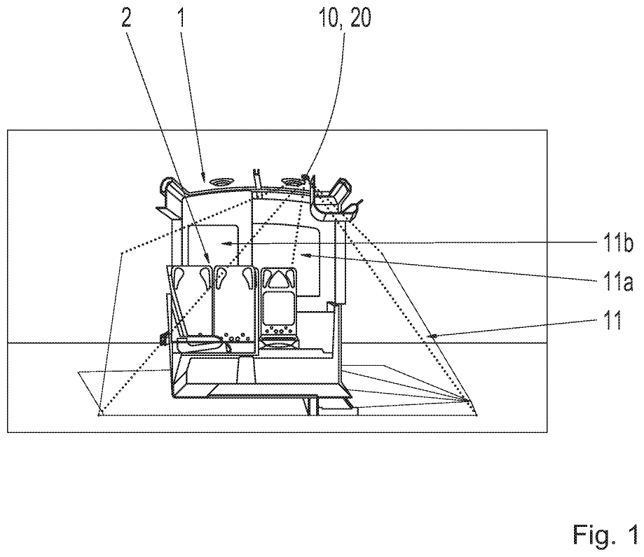

FIG. 1 shows a section of a people mover 1 according to the present disclosure. The people mover 1 comprises a passenger cabin 2. The passenger cabin 2 is perceived by a first TOF sensor 10 and a second TOF sensor 20, of which only the first TOF sensor is shown in FIG. 1. The first TOF sensor 10 has a first field of view 11. Portions or regions of the first field of view 11 may be concealed by objects and therefore cannot be perceived by the first TOF sensor 10 and the second TOF sensor 20. A first visible field of view 11a, i.e., the portion of the first field of view 11 that is fully perceived by the first TOF sensor 10, perceives the region of a passenger door 3. There is a first visible plane 11b in this first visible field of view 11a. The same applies for the second TOF sensor 20.

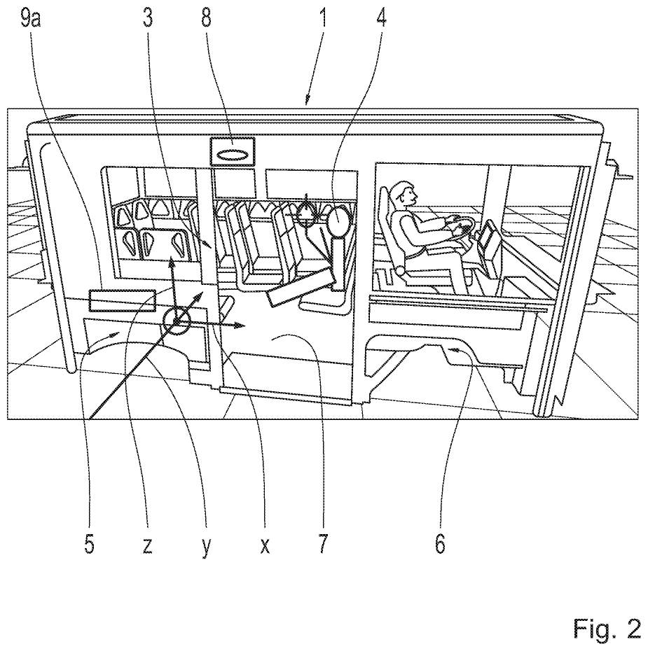

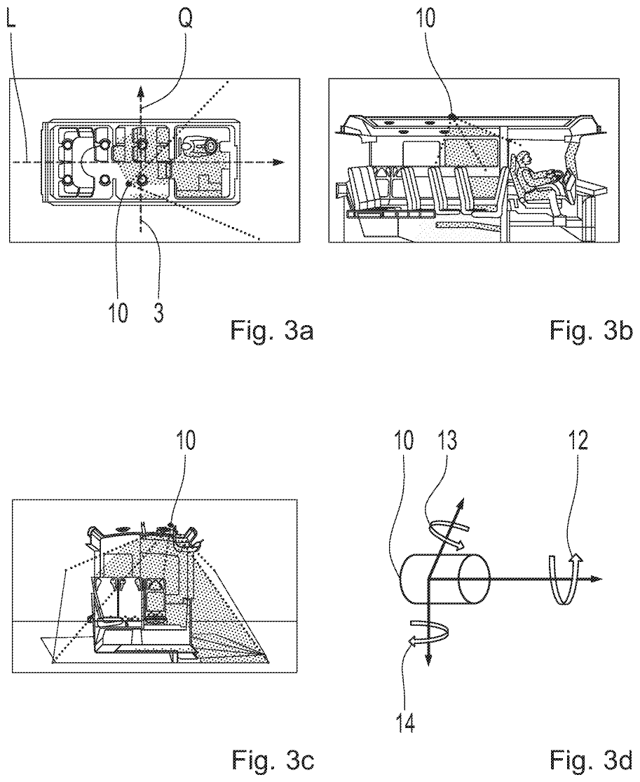

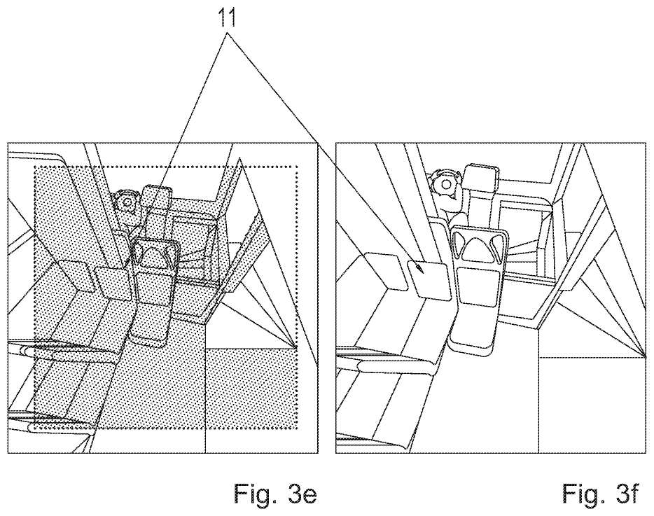

FIG. 2 shows an example layout of the people mover 1. The people mover 1 is driven by a driver here. The driver sits in the driver cabin. The passenger door 3 is automatically opened and closed by a control mechanism 8 in the form of a servomotor. A passenger 4 sits in the passenger cabin 2. Passengers can also stand, i.e., on the floor of the people mover 1. The regions of a front axle 6 and a rear axle 5 of the people mover 1 are also indicated. The front axle 6 and/or the rear axle 5 are electrically powered axles. A control device 9a controls the electric motor for the rear axle 5 and a steering of the people mover 1. A Cartesian coordinate system has a point of origin in the middle of the rear axle 5. The x-axis runs parallel to a longitudinal axis L of the people mover 1. The y-axis runs parallel to a transverse axis Q of the people mover 1. The z-axis is perpendicular to the floor of the people mover 1. The longitudinal axis L and the transvers axis Q are indicated in FIG. 3.

FIGS. 3a to 3c show various illustrations of the placement of the first TOF sensor 10. The first TOF sensor 10 is located in the coordinate system shown in FIG. 2 at x=1.044, y=−0.460, and z=1.90. A first roll angle 12 is 14°. A first pitch angle 13 is 56°. A first yaw angle 14 is 11°.

The axes defining the first roll angle 12, the first pitch angle 13, and the first yaw angle 14 are indicated in FIG. 3d.

These position and angular set-ups surprisingly result in a particularly advantageous first field of view 11 with regard to detecting a blockage of the passenger door 3 and the number of passengers in a horizontal and vertical field of view of 85° in each case, and a maximum range of the 2 meters for the first TOF sensor.

This particularly advantageous first field of view 11 is illustrated schematically in FIG. 3e and shown as an image from the first TOF sensor 10 in FIG. 3f.

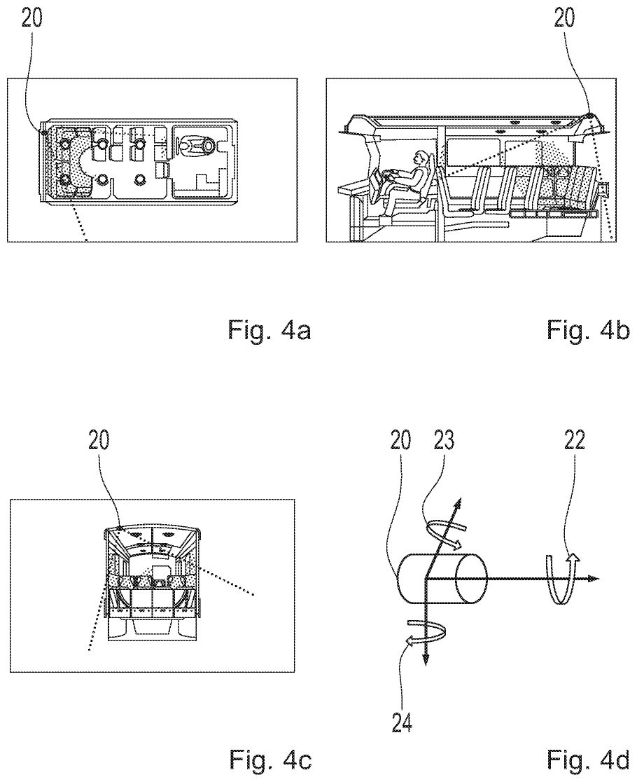

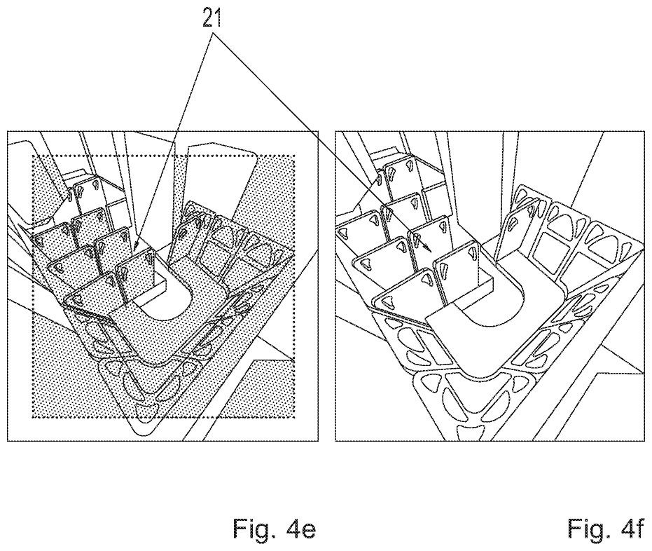

FIGS. 4a to 4c show various illustrations of the placement of the second TOF sensor 20. The second TOF sensor 20 is located in the coordinate system shown in FIG. 2 at x=−0575, y=−0.630, and z=2.077. A second roll angle 22 is 14°. A second pitch angle 23 is 56°. A second yaw angle 24 is −43°.

The axes defining the second roll angle 22, the second pitch angle 23 and the second yaw angle 24 are indicated in FIG. 4d.

These position and angular placements surprisingly result in a particularly advantageous first field of view 21 with regard to detecting a blockage of the passenger door 3 and the number of passengers in a horizontal and vertical field of view of 85° in each case, and a maximum range of the 2 meters for the first TOF sensor.

This particularly advantageous first field of view 21 is illustrated schematically in FIG. 4e and shown as an image from the first TOF sensor 20 in FIG. 4f.

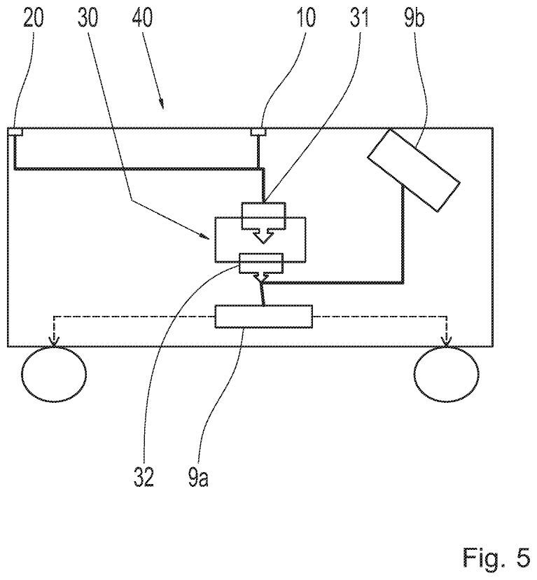

FIG. 5 shows an exemplary embodiment of a perception system 40 according to the present disclosure in the people mover 1. The perception system 40 comprises a set-up according to the present disclosure of the first TOF sensor 10 and the second TOF sensor 20. The perception system also comprises an evaluation platform 30.

The evaluation platform 30 is a computer platform, for example. The platform 30 comprises a first interface 31 for the first TOF sensor 10 and the second TOF sensor 20. The platform 30 receives raw data from the first TOF sensor 10 and the second TOF sensor 20 via the first interface 31. These raw data are processed by the platform 30, e.g., according to an algorithm for detecting and classifying people. Based on the processed raw data, the platform 30 can determine whether the passenger door 3 is blocked by a passenger 4, and outputs a first signal to the control mechanism 8 via a second interface 32 in order to keep the passenger door open if this is the case. The first signal is also sent to a display 9b, in order to indicate to the passenger 4 blockage the passenger door 3 to move away from the region of the passenger door 3. The perceiving by the first TOF sensor 10, the control mechanism 8, and the display 9b are interconnected. This means that if the first TOF sensor 10 detects that the region of the passenger door 3 is not blocked, the control mechanism 8 closes the passenger door 3, and the message is removed from the display 9b. Based on the processed data, the platform 30 also detects the positions, poses and activities of the passengers 4 in the passenger cabin 2, and outputs a corresponding second signal to the control device 9a via the second interface 32, in order to control the people mover 1 based on the positions, poses, and/or activities of the passengers 4. The platform 30 also detects how many passengers 4 are in the passenger cabin 2 based on the processed raw data, preferably based on a fusion of the raw data from the first TOF sensor 10 and the raw data from the second TOF sensor 20. This number of passengers 4 is sent to the display 9b in the form of a third signal, in order to inform the passengers 4 of the number of passengers 4.

### REFERENCE SYMBOLS

1 people mover
2 passenger cabin
3 passenger door
4 passenger
5 rear axle
6 front axle
7 floor
8 control mechanism
9a control device
10 first TOF sensor
11 first field of view
11a first visible field of view
11b first visible plane in the first field of view
12 first roll angle
13 first pitch angle
14 first yaw angle
15 second TOF sensor
21 second field of view
22 second roll angle
23 second pitch angle
24 second yaw angle
30 evaluation device
31 first interface
32 second interface
40 perception system
L longitudinal axis
Q transverse axis
x x-axis
y y-axis
z z-axis

1. A system comprising:
a first time-of-flight (TOF) sensor arranged such that a first field of view of the first TOF sensor perceives a region surrounding a passenger door of a passenger cabin of a people mover in order to detect a blockage of the passenger door and to count a number of passengers located in the passenger cabin; and
a second TOF sensor arranged such that a second field of view of the second TOF sensor perceives the passengers located in the passenger cabin in order to detect at least one of a position, activity, or pose of the passengers, and to count a number of passengers located in the passenger cabin.

2. The system according to claim 1, wherein the first TOF sensor is arranged such that the first field of view detects at least one passenger who has entered the people mover and is located in the region of the passenger door.

3. The system according to claim 1,
wherein a coordinate system comprises:
a point of origin in the middle of a rear axle of the people mover;
an x-axis running along a longitudinal axis of the people mover toward a front axle of the people mover;
a y-axis running perpendicular to the x-axis, along a transverse axis of the people mover, away from the passenger door; and
a z-axis running perpendicular to both the x-axis and the y-axis, away from a floor of the people mover;
wherein the first TOF sensor is located at a first position defined within the coordinate system having:
a first x coordinate within a range of 1.000 to 1.100 meters,
a first y coordinate within a range of −0.600 to −0.200 meters, and
a first z coordinate within a range of 1.700 to 2.000 meters, and
the second TOF sensor is located at a second position defined within the coordinate system having:
a second x coordinate within a range of −0.800 to −0.200 meters,
a second y coordinate within a range of −0.800 to −0.400 meters, and
a second z coordinate within a range of 1.800 to 2.150 meters.

4. The system according to claim 1, wherein:
the first TOF sensor is arranged such that:
a first roll angle of the first TOF sensor is in a range of 10° to 18°,
a first pitch angle of the first TOF sensor is in a range of 50° to 60°,
a first yaw angle of the first TOF sensor is in a range of 6° to 14°; and
the second TOF sensor is arranged such that:
a second roll angle of the second TOF sensor is in a range of 10° to 18°,
a second pitch angle of the second TOF sensor is in a range of 50° to 60°, and
a second yaw angle of the second TOF sensor is in a range of −50° to −40°.

5. The system according to claim 1, further comprising:
a platform for perceiving the passenger cabin of the people mover, comprising at least one first interface for receiving data from the first TOF sensor and the second TOF sensor;
wherein the platform is configured to:
detect a blockage of the passenger door of the people mover by a passenger based on the data from the first TOF sensor, and generate a first signal to at least one of keep the passenger door open or stop the blockage by the passenger;
detect positions the passengers assume based on the data from the second TOF sensor, further comprising:
determining how many of the passengers are at least one of sitting, standing, walking, or lying in the passenger cabin;
determining poses the passengers assume; and
determining activities the passengers are engaged in; and
generate a second signal containing information regarding at least one of the positions, poses, or the activities of the passengers; and
determine a number of passengers in the passenger cabin based on at least one of the data from the first TOF sensor or the data from the second TOF sensor; and
generate a third signal containing information regarding the number of passengers; and
wherein the platform further comprises at least one second interface configured to:
send the first signal to at least one of a control mechanism for the passenger door or the passenger blocking the passenger door, and
send at least one of the second signal or the third signal to at least one of a control device in the people mover or a display on the people mover.

6. (canceled)

7. The system according to claim 1, wherein the first TOF sensor is arranged such that the first field of view detects at least one of a finger, a foot, or a shoe of a passenger in the region of the passenger door when the passenger is located at least one of outside or inside the people mover.

8. The system according to claim 3,
wherein the first TOF sensor is located at a first position defined within the coordinate system having:
the first x coordinate equal to 1.044 meters,
the first y coordinate equal to −0.460 meters, and
the first z coordinate equal to 1.900 meters.

9. The system according to claim 3,
wherein the second TOF sensor is located at a second position defined within the coordinate system having:
the second x coordinate equal to −0.575 meters,
the second y coordinate equal to −0.630 meters, and
the second y coordinate equal to 2.077 meters.

10. The system according to claim 4,
wherein the first TOF sensor is arranged such that:
the first roll angle of the first TOF sensor is 14°,
the first pitch angle of the first TOF sensor is 56°, and
the first yaw angle of the first TOF sensor is 11°.

11. The system according to claim 4,
wherein the second TOF sensor is arranged such that:
the second roll angle of the second TOF sensor is 14°,
the second pitch angle of the second TOF sensor is 56°, and
the second yaw angle of the second TOF sensor is −43°.

12. A method of arranging time-of-flight (TOF) sensors within a passenger cabin of a people mover, the method comprising:
arranging a first TOF sensor within the passenger cabin such that a first field of view of the first TOF sensor perceives a region surrounding a passenger door of a passenger cabin of a people mover in order to detect a blockage of the passenger door and to count a number of passengers located in the passenger cabin; and
arranging a second TOF sensor within the passenger cabin such that a second field of view of the second TOF sensor perceives the passengers located in the passenger cabin in order to detect at least one of a position, activity, or pose of the passengers, and to count a number of passengers located in the passenger cabin.

13. The method according to claim 12,
wherein a coordinate system comprises:
a point of origin in the middle of a rear axle of the people mover;
an x-axis running along a longitudinal axis of the people mover toward a front axle of the people mover;
a y-axis running perpendicular to the x-axis, along a transverse axis of the people mover, away from the passenger door; and
a z-axis running perpendicular to both the x-axis and the y-axis, away from a floor of the people mover;
wherein the method further comprises:
arranging the first TOF sensor at a first position defined within the coordinate system having:
a first x coordinate within a range of 1.000 to 1.100 meters,
a first y coordinate within a range of −0.600 to −0.200 meters, and
a first z coordinate within a range of 1.700 to 2.000 meters; and
arranging the second TOF sensor at a second position defined within the coordinate system having:
a second x coordinate within a range of −0.800 to −0.200 meters,
a second y coordinate within a range of −0.800 to −0.400 meters, and
a second z coordinate within a range of 1.800 to 2.150 meters.

14. The method according to claim 13, further comprising:
arranging the first TOF sensor at the first position defined within the coordinate system having:
the first x coordinate equal to 1.044 meters,
the first y coordinate equal to −0.460 meters, and
the first z coordinate equal to 1.900 meters.

15. The method according to claim 13, further comprising:
arranging the second TOF sensor at the second position defined within the coordinate system having:
the second x coordinate equal to −0.575 meters,
the second y coordinate equal to −0.630 meters, and
the second y coordinate equal to 2.077 meters.

16. The method according to claim 12, further comprising:
arranging the first TOF sensor such that:
a first roll angle of the first TOF sensor is in a range of 10° to 18°,
a first pitch angle of the first TOF sensor is in a range of 50° to 60°, and
a first yaw angle of the first TOF sensor is in a range of 6° to 14°; and
arranging the second TOF sensor such that:
a second roll angle of the second TOF sensor is in a range of 10° to 18°,
a second pitch angle of the second TOF sensor is in a range of 50° to 60°, and
a second yaw angle of the second TOF sensor is in a range of −50° to −40°.

17. The method according to claim 16, further comprising:
arranging the first TOF sensor such that:
the first roll angle of the first TOF sensor is 14°,
the first pitch angle of the first TOF sensor is 56°, and
the first yaw angle of the first TOF sensor is 11°.

18. The method according to claim 16, further comprising:
arranging the second TOF sensor such that:
the second roll angle of the second TOF sensor is 14°,
the second pitch angle of the second TOF sensor is 56°, and
the second yaw angle of the second TOF sensor is −43°.
